(19) United States
(12) Patent Application Publication
(10) Pub. No.: US 2017/0070132 A1
(43) Pub. Date: Mar. 9, 2017

(54) Linear Vibrator

(71) Applicants: Hongxing Wang, Shenzhen (CN); Yao Wang, Shenzhen (CN)

(72) Inventors: Hongxing Wang, Shenzhen (CN); Yao Wang, Shenzhen (CN)

(73) Assignee: AAC Technologies Pte. Ltd., Singapore city (SG)

(21) Appl. No.: 15/082,385

(22) Filed: Mar. 28, 2016

(30) Foreign Application Priority Data
Sep. 7, 2015 (CN) 201520688250.9

(51) Int. Cl. H02K 33/14

(52) U.S. Cl. CPC H02K 33/14

(57) ABSTRACT

A linear vibrator is disclosed. The linear vibrator includes a fixed part including a housing which has an accommodation space, and a circuit board disposed in the accommodation space; a vibration part; an elastic connecting part including one end connected with the vibration part, and another end connected with the housing for suspending the vibration part in the accommodation space; and a Hall sensor connected electrically with the circuit board for sensing the motion state of the vibration part. One of the fixed part and the vibration part includes a coil, and the other includes a magnet opposite to the coil.

### FIELD OF THE INVENTION

The present invention relates to consumer electronics, more particularly to a linear motor used in a consumer electronic device for providing tactile feedback.

### DESCRIPTION OF RELATED ART

The vibration motor is applied to feedback of the system generally, such as incoming call prompt, message prompt and navigation prompt of mobile phone, vibration feedback of game player, etc. for the portable consumer electronic products which are favored by more and more people along with development of the electronic technologies, such as mobile phone, handheld game player, navigation unit or handheld multimedia entertainment equipment, etc. Thus, the vibration motor is required to have obvious vibration effect and simple assembling as a result of such wide application.

The vibration motor of related technologies usually includes a fixed part and a vibration part. And the fixed part includes a housing which has an accommodation space as well as a coil which is set inside the housing. The vibration part is set inside the accommodation space of the housing through an elastic element, and it includes a magnet and a clump weight which is used for receiving magnets. After the coil is electrified with alternating current, it will interact with the magnet, producing magnetic field force. Because the coil doesn't move, the whole vibration part will be affected by the magnetic force and perform the reciprocating vibration supported by the elastic element. However, the liner motors of related technologies are all without hall sensor. Therefore, the exact location of the vibration parts during operation cannot be distinguished, accordingly their motion states cannot be controlled effectively neither.

Therefore, it is necessary to provide a new linear vibrator to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustration of a linear vibrator in accordance with a first exemplary embodiment of the present disclosure.

FIG. 2 is an illustration of a linear vibrator in accordance with a second exemplary embodiment of the present disclosure.

FIG. 3 is an illustration of a linear vibrator in accordance with a third exemplary embodiment of the present disclosure.

### DETAILED DESCRIPTION OF THE EXEMPLARY EMBODIMENTS

The present invention will hereinafter be described in detail with reference to several exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

### The First Embodiment

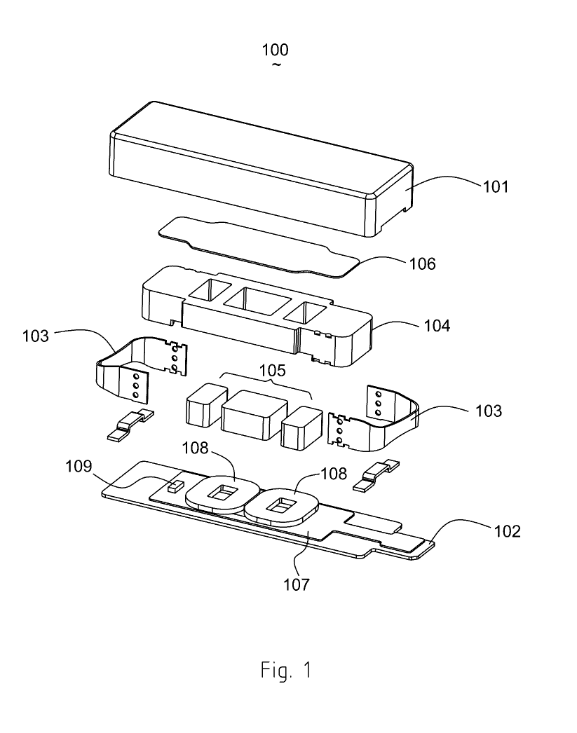

As shown in FIG. 1, a linear motor 100 in accordance with a first embodiment of the present disclosure includes a fixed part, a vibration part and an elastic connecting part 103.

The fixed part includes a housing which has an accommodation space, a circuit board 107 disposed in the accommodation space, and two coils 108 fixed on and connected electrically with the circuit board 107. The housing includes an upper cover 101 and a cover board 102 forming the accommodation space together with the upper cover 101. The circuit board 107 is arranged on the cover board 102.

The vibration part includes a magnet 105 located opposed to the coil 108, and a mass block 104 used for receiving the magnet 105. One end of the elastic connecting part 103 is connected with the mass block 104, and the other end is connected with the housing for suspending the vibration part in the accommodation space of the housing. Three through-holes are formed in the mass block 104, and each one receives a magnet 105 therein.

The linear motor also includes a Hall sensor 109, which is set on the fixed part and connected with circuit board 109 electrically. The Hall sensor 109 should be fixed on the fixed part. As a kind of magnetic sensor based on hall-effect, Hall sensor 109 can be used to detect magnetic field as well as its change. According to this principle, Hall sensor 109 can be used for sensing the motion state of vibration part.

In this embodiment, the coil 108 is on the right of the figure, and the Hall sensor 109 is fixed on the circuit board 107, which lies on one side of the coil 108. In other word, Hall sensor 109 can be fixed on the same circuit board 107 together with the coil 108. And Hall sensor 109 usually has four ports (four metal PAD specifically), among which two ports are used for operating current and the other two are used for outputting hall voltage. And these four ports can share the FPC layer with the coil 108, so that it only needs to add some more corresponding interface ports on the FPC without increasing its width.

Of course, the Hall sensor 109 can also be located in other positions, such as being below of any magnet or any other position. Usually the coil 108 is annular, so the Hall sensor 109 can also be set in the center of a coil 108 and set opposite to the magnet 105. It's worth noting that the location of the Hall sensor 109 in the linear motor 100 needs to have no influences on vibration part's amplitude as well as the reliability of vibration.

In other embodiment, fixed part includes a magnet which is set inside the housing. Vibration part includes a clump weight as well as a coil connected with it. Hall sensor is set on the magnet or on the housing opposite to the coil.

### The Second Embodiment

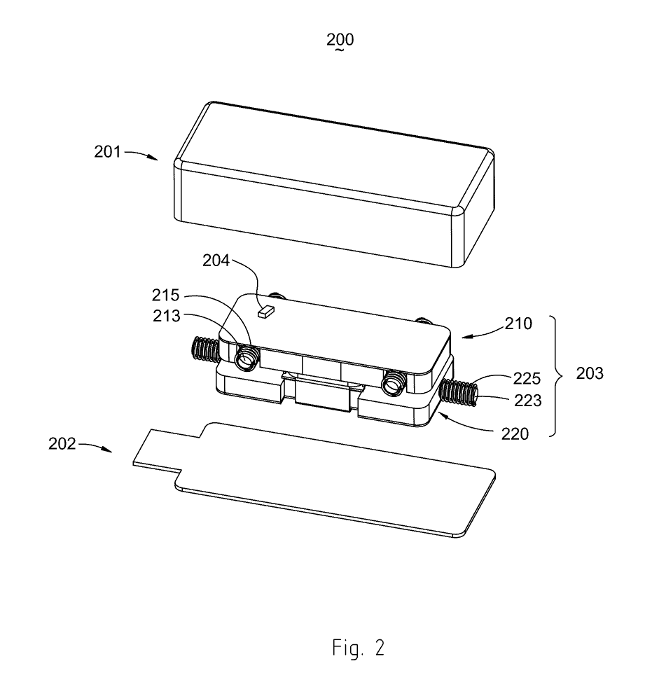

As shown in FIG. 2, a linear motor 200 in accordance with a second exemplary embodiment of the present disclosure includes a fixed part, a vibration part 203 and an elastic connecting part. Being different from the previous embodiment, the Hall sensor 204 is fixed and set on the vibration part 203.

The fixed part includes a housing with an accommodation space, a coil and a circuit board (not shown). The housing includes an upper cover 201 and a cover board 202 forming the accommodation space together with the upper cover 201.

The vibration part 203 includes a first vibration part 210 and a second vibration part 220. Both the first vibration part 210 and the second vibration part 220 include clump weight as well as magnet which is received in the clump weight. The coil is set between the magnets of the first vibration part and the second vibration part through a support. The magnetic field, which is produced after the coil is electrified, interacts with the magnets of the first vibration part and the second vibration part, producing attractive force and repulsive force. Then the first vibration part 210 and the second vibration part 220 are drove to vibrate respectively along the first vibration direction as well as the second vibration direction inside the housing. Preferably, the first vibration direction is along the width of the housing (that is the Y-axis direction). And the second vibration direction is along the length of the housing (that is the X-axis direction).

In this embodiment, the first vibration part 210 and the second vibration part 220 are supported elastically inside the housing through the cooperation of a kind of axle hole. The first vibration part 210 includes the first guide axle 213 which is set through the clump weight along the first vibration direction, with both ends respectively fixed on the housing. The second vibration part 220 includes the second guide axle 223 which is set through the clump weight along the second vibration direction, with both ends respectively fixed on the housing. Elastic connecting part includes the first spring 215 which is set on both ends of the first guide axle 213 and lying between the clump weight and housing, as well as the second spring 225 which is set on both ends of the second guide axle 223 and lying between the clump weight and housing.

The Hall sensor 204 is set on the clump weight of the first vibration part 210. When the second vibration part 220 moves relatively to the first vibration part 210, the Hall sensor 204 can detect the motion state of the second vibration part 220. Hall sensor 204 can also be fixed on the second vibration part 220 to detect the motion state of the first vibration part 210.

### The Third Embodiment

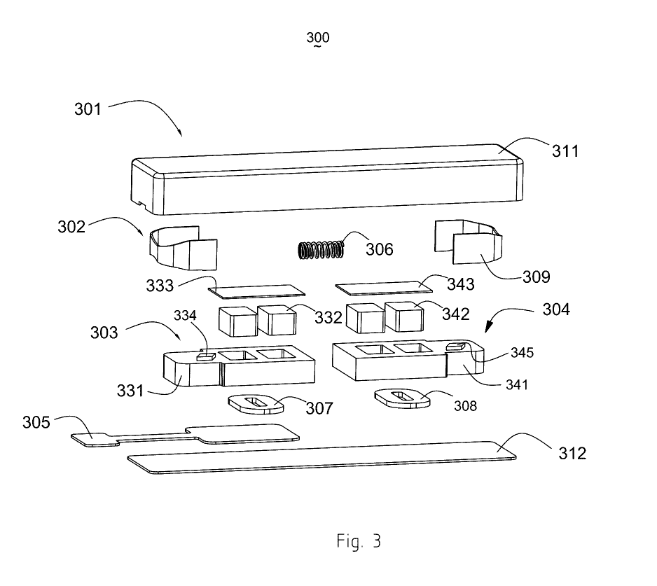

As shown in FIG. 3, the linear motor 300 includes a fixed part, a vibration part and an elastic connecting part 300. And the fixed part includes a housing 301 with an accommodation space, a coil 307, a coil 308 as well as a circuit board 305. The housing includes an upper cover 311 as well as a cover board 312 which forms the accommodation space together with the upper cover 311. The circuit board 305 is fixed on the cover board 312, and coil 307 as well as the coil 308 are both fixed on the circuit board 305 and connected with it electrically.

The vibration part includes the first vibration part 303 and the second vibration part 304. And the first vibration part 210 includes the first clump weight 331, the first magnet 332 received in the first clump weight 331 as well as the first pole shank 333 covering on the surface of the first clump weight 331. The coil 307 and the first magnet 332 are configured to be opposed to each other. The second vibration part 304 includes a second clump weight 341, a second magnet 342 received in the first clump weight 341, as well as a second pole shank 343 covering on the surface of the second clump weight 341. The coil 308 and the second magnet 342 are opposed to each other.

The elastic connecting part includes a spring 306 located between the first vibration part 303 and the second vibration part 304, as well as a leaf spring 309 which ensures the elastic suspension of the first vibration part 303 and the second vibration part 304 inside the housing 301.

In this embodiment, both the first vibration part 303 and the second vibration part 304 can provide driving force. And they can provide vibration sense at different frequencies.

Being different from the previous one, in this embodiment, the Hall sensor 334 is located on the first clump weight 331 of the first vibration part 303, and another Hall sensor 345 locates on the second clump weight 341 of the second vibration part 304. The Hall sensor 334 is used to detect the motion state of the second vibration part 304, and the Hall sensor 345 is used to detect the motion state of the first vibration part 303.

In conclusion, the linear motor with Hall sensor can output information about the motion state of the vibration part when it is working, so that the system can control the motion state of it. All of these can contribute to the better vibration sense, especially in condition that more than one linear motor are used for driving jointly.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A linear motor, including:
a fixed part including a housing which has an accommodation space, and a circuit board disposed in the accommodation space;
a vibration part;
an elastic connecting part including one end connected with the vibration part, and another end connected with the housing for suspending the vibration part in the accommodation space;
a Hall sensor connected electrically with the circuit board for sensing the motion state of the vibration part; wherein
one of the fixed part and the vibration part includes a coil, and the other includes a magnet opposite to the coil.

2. The linear motor as described in claim 1, wherein the Hall sensor is set on the fixed part.

3. The linear motor as described in claim 2, wherein the fixed part includes a coil fixed on the circuit board and connected with the circuit board electrically, and the Hall sensor locates on the circuit board.

4. The linear motor as described in claim 3, wherein the housing includes an upper cover and a cover board which forms the accommodation space together with the upper cover, the circuit board locates on the cover board, and the coil and the Hall sensor are arranged on the circuit board.

5. The linear motor as described in claim 4, wherein the Hall sensor locates at one side of the coil.

6. The linear motor as described in claim 4, wherein the coil is annular, and the Hall sensor is arranged at the center of the coil.

7. The linear motor as described in claim 1, wherein the fixed part includes the magnet in the housing, the vibration part includes a clump weight as well as a coil which is connected with the clump weight, and the Hall sensor locates on the magnet or on the housing which is set opposite to the coil.

8. The linear motor as described in claim 1, wherein the Hall sensor is arranged on the vibration part.

9. The linear motor as described in claim 8, wherein the vibration part includes a first vibration part and a second vibration part, the Hall sensor is arranged on the first vibration part or the second vibration part.
